(19) United States
(12) Patent Application Publication
(10) Pub. No.: US 2024/0212523 A1
(43) Pub. Date: Jun. 27, 2024

(54) FREE-FALL EXPERIMENTAL APPARATUS FOR HIGH SCHOOL PHYSICS

(71) Applicant: Yuxuan Shang, Irvine, CA (US)

(72) Inventor: Yuxuan Shang, Irvine, CA (US)

(21) Appl. No.: 18/411,808

(22) Filed: Jan. 12, 2024

(30) Foreign Application Priority Data
Jan. 17, 2023 (CN) 202310061826.8

(51) Int. Cl. G09B 23/10

(52) U.S. Cl. CPC G09B 23/10

(57) ABSTRACT

A free-fall experimental apparatus for high school physics is disclosed. The apparatus includes a base, said base being installed with a negative pressure component for negative pressure pumping within the experimental assembly; said base being installed with a height adjustment component for adjusting the experimental height of the experimental assembly; said base being installed with an experimental assembly for conducting a free-fall experiment; said experimental assembly comprising a pulling type movable assembly, an experimental block, an upper opening self-resetting assembly, a retractable assembly and a lower opening self-resetting assembly.

### CROSS-REFERENCE TO RELATED APPLICATIONS

This application claims priority to and benefits of Chinese Patent Application No. 2023100618268 filed with China National Intellectual Property Administration on Jan. 17, 2023 and entitled “A FREE-FALL EXPERIMENTAL APPARATUS FOR HIGH SCHOOL PHYSICS”, the entire contents of each of which are herein incorporated by reference for all purposes. No new matter has been introduced.

### FIELD

The present invention relates to the technical field of physics experimental apparatus, and specifically relates to a free-fall experimental apparatus for high school physics.

### BACKGROUND

Free-fall experiment is one of the important experiments in high school physics study, which is a uniformly accelerated linear motion with zero initial velocity. Free-fall experimental apparatus is used to help students perform free-fall experiments in order to calculate the acceleration of free-fall motion.

For example, Chinese invention patent CN201910442563.9 discloses a high school physics free-fall experiment simulation device, in which an experimental sleeve is slid and stretched by adjusting the height of an adjustable crossbar and a bearing plate to adjust the height of the fall of an experimental ball, and a vacuum pump is used to evacuate the experimental assembly and create a vacuum interior, and the experimental ball is released in order to perform free-fall experiment demonstration. However, the above structure has the following problems:
First of all, when releasing the experimental ball, the output end contracts by activating the electric actuator, so that the pallets shrinks and gradually separates from the experimental ball. and at this time, due to the gradual increase of the gap between the pallets, the experimental ball will move downward gradually. The center of gravity of the experimental ball will gradually move downward with a certain velocity until the experimental ball completely separates from the pallet. And the experimental ball will have a certain initial velocity and then will move downward. Since the experimental ball does not have an initial velocity of zero, this affects the accuracy of calculating the acceleration of free-fall. secondly, after the experimental ball falls, it requires a cumbersome process of repeatedly realizing the picking up of the ball and the height adjustment, which is not conducive to repeated experiments.

Based on this, the present invention designs a free-fall experimental apparatus for high school physics to solve the above problems.

### SUMMARY

In response to the above drawbacks existing in the prior art, the present invention provides a free-fall experimental apparatus for high school physics.

In order to achieve the above purpose, the present invention is realized by the following technical solutions:
A free-fall experimental apparatus for high school physics, comprising a base, said base being fitted with a negative pressure assembly for negative pressure pumping within an experimental assembly;
Said base is fitted with a height adjusting assembly for adjusting the experimental height of the experimental assembly;
Said base is fitted with an experimental assembly for conducting free-fall experiments;
Said experimental assembly includes a pulling type movable assembly, an experimental block, an upper opening self-resetting assembly, a retractable assembly, and a lower opening self-resetting assembly;
Said experimental block is mounted to said pulling type movable assembly, said pulling type movable assembly is mounted to said upper opening self-resetting assembly, said upper opening self-resetting assembly is connected to the upper end of said retractable assembly, said retractable assembly is connected to said height adjusting assembly, said lower opening self-resetting assembly is mounted to said base, and said lower opening self-resetting assembly is connected to the lower end of said retractable assembly;
Said retractable assembly is fitted with a sensing assembly for detecting said experimental block.

Still further, said upper opening self-resetting assembly comprises a top sleeve, a first slide plate and a second spring; said top sleeve is plug-in mounted on the upper end of said retractable assembly, said first slide plate is fixedly connected to the side wall of said top sleeve, said first slide plate is slidingly connected to said height adjusting assembly, and said first slide plate is fitted with a second spring, the lower end of said second spring is fixedly connected to said first slide plate, and the upper end of said second spring is fixedly connected to said height adjusting assembly.

Further, s said pulling type movable assembly comprises a pulling plate, a first blocking plate, a second blocking plate and a fourth spring; said pulling plate (310) is slidingly connected to the side wall of said top sleeve, and the inner bottom of said top sleeve is fixedly connected with the first blocking plate and second blocking plate, one end of said pulling plate passes through said second blocking plate, said experimental block successively and then contacts and connects to the side wall of said first blocking plate, said experimental block is provided with a hole through which said pulling plate passes, said pulling plate is fitted with a fourth spring, said fourth spring is fitted with a fourth spring, and said third spring is fitted with a fourth spring, said fourth spring is located inside said top sleeve, with one end being fixedly connected to said pull plate, and the other end being fixedly connected to the inner wall of said top sleeve.

Further, said retractable assembly comprises an adjusting sleeve, a fixing sleeve and an installation crossbar; the lower end of said fixing sleeve is fixedly mounted on said installation crossbar, the other end of said installation crossbar is fixedly mounted on said height adjusting assembly, said fixing sleeve is slidingly connected at the upper end to the interior of said adjusting sleeve, said adjusting sleeve is connected to said height adjusting assembly, said adjusting sleeve is provided at the top with a slot for mating with the bottom of said top sleeve; the internal lower end of said adjusting sleeve is fixedly connected with a sealing ring for sealing the connection of said adjusting sleeve with said fixing sleeve.

Still further, said lower opening self-resetting assembly comprises a buffer sleeve, a slide sleeve, a first spring, a third spring and a buffer plate; the bottom of said buffer sleeve is fixedly mounted on said base, and the inner bottom of said buffer sleeve is fixedly connected with a number of sets of third springs, the top of said third springs is fixedly connected with said buffer plate respectively, said buffer plate is mounted on the interior of said buffer sleeve, the inner wall of the lower end of said slide sleeve is in sliding contact with the outer wall of the upper end of said buffer sleeve, and the outer wall of the lower end of said fixed sleeve is sliding contact with the inner wall of the top of said top inner wall of said slide sleeve, the first spring is mounted at the lower end of said fixed sleeve, said first spring is located below said installation crossbar, the upper end of said first spring is fixedly connected to said installation crossbar, the lower end of said first spring is fixedly connected to said top of said slide sleeve.

Further, said fixed sleeve is fixedly connected at its bottom with an anti-dislodgement ring, said anti-dislodgement ring is in sliding contact with the inner wall of said slide sleeve, and the outer diameter of said anti-dislodgement ring is larger than the inner diameter of the top of said slide sleeve.

Still further, the internal lower end of said slide sleeve is fixedly connected with a sealing ring for sealing the connection between said slide sleeve and said buffer sleeve; the internal upper end of said slide sleeve is fixedly connected with a sealing ring for sealing the connection between said slide sleeve and said fixed sleeve.

Still further, said height adjusting assembly comprises a scale, a second slide plate, a rocker, a support bracket, a threaded bar and a pointer; the lower end of said scale is fixedly connected to said base, the upper end of said scale is fixedly connected to the support bracket, the threaded bar is rotationally mounted on said support bracket, the rocker is fixedly connected to the top of said threaded bar, the threaded bar is threadedly connected with the second sliding plate, with one end in sliding contact with the scale ruler, and the other end fixedly connected to the upper end of the adjusting sleeve, the upper end of the adjusting sleeve is fixedly connected with the horizontal pointer, which coincides with the horizontal line where the center of gravity of the experimental block is located, one end of the pointer indicates the graduation line on the scale ruler.

Further, said sensing assembly comprises a first infrared sensor, a second infrared sensor and a controller; said second infrared sensor and said first infrared sensor are fixedly mounted at the upper and lower ends of said fixing sleeve respectively, and said controller is fixedly mounted at the upper end of said scale.

Further, said negative pressure assembly comprises a pumping pump, a pumping pipe and a control valve; said pumping pump is fixedly mounted on said base, the pumping end of said pumping pump is fixedly connected to a pumping pipe, said pumping pipe is mounted with a control valve, the other end of said pumping pipe is fixedly connected to said buffer sleeve.

The present invention is realized by moving the pulling type movable assembly laterally to make the experimental block be detached from the pulling type movable assembly, during which the experimental block does not move up and down or left and right, and the initial velocity is zero, then detecting the experimental block by the sensing assembly, and measuring the time it takes for the experimental block to fall down to the detected position. The present invention satisfies that the initial velocity of the experimental block is zero, and therefore helps to ensure the accuracy of calculating the acceleration of free-fall and reduce errors.

After conducting a free-fall experiment of this invention, the lower open self-resetting components is opened to take out the experimental block, and automatically reset closed when releasing, then the upper open self-resetting components is opened, the experimental block is mounted by pulling the pulling type activity components, and automatically closing of the upper open self-resetting component when releasing can be realized. There is no need to adjust the height of the experiments back and forth during repeated experiments, and thus it is more convenient for the operation. When it requires to adjust the experimental height, the height adjusting component is activated to extend the retractable component, so as to realize the adjustment of the experimental height. Since the same experimental height needs to be adjusted only once, this invention solves the problems in the prior art where a more cumbersome method is used to repeatedly pick up the ball and adjust the height, which is not conducive to conducting multiple repeated experiments.

### BRIEF DESCRIPTION OF THE DRAWINGS

In order to more clearly illustrate the technical solutions in the embodiments or prior art of the present invention, the accompanying drawings to be used in the description of the embodiments or prior art will be briefly described below. Obviously, the accompanying drawings in the following description are only some of the embodiments of the present invention, and other accompanying drawings may be obtained based on these drawings by a person of ordinary skill in the art without creative labor.

FIG. 1 shows a three-dimensional view I of the main structure of a free-fall experimental apparatus for high school physics of the present invention;

FIG. 2 shows a front view of the structure of a free-fall experimental apparatus for high school physics of the present invention;

FIG. 3 shows a left view of the structure of a free-fall experimental apparatus for high school physics of the present invention;

FIG. 4 shows a three-dimensional view II of the main structure of a free-fall experimental apparatus for high school physics of the present invention;

FIG. 5 shows a three-dimensional view III of the main structure of a free-fall experimental apparatus for high school physics of the present invention;

FIG. 6 shows a sectional view along the A-A direction of FIG. 3;

FIG. 7 shows an enlarged view at B in FIG. 6.

The description of symbols: 1. base; 2. negative pressure assembly; 21. pump; 22. pumping pipe; 23. control valve; 3. experimental assembly; 31. buffer sleeve; 32. slide sleeve; 33. first spring; 34. installation crossbar; 35. regulating sleeve; 36. top sleeve; 37. first slide plate; 38. second spring; 39. fixing sleeve; 310. pulling plate; 311. third spring; 312. buffer plate; 313. anti-detachment ring; 314. slot; 315. experimental block; 316. first blocking plate; 317. second blocking plate; 318. fourth spring; 319. pulling type movable assembly; 320. upper opening self-resetting assembly; 321. retractable assembly; 322. lower opening self-resetting assembly; 4. height adjusting assembly; 41. graduated scale; 42. second sliding plate; 43. rocker; 44. support bracket; 45. threaded bar; 46. pointer; 5. sensing assembly; 51. first infrared sensor; 52. second infrared sensor; 53. controller.

### DETAILED DESCRIPTION OF THE DISCLOSURE

In order to make the objects, technical solutions and advantages of the embodiments of the present invention clearer, the technical solutions in the embodiments of the present invention will be described clearly and completely in the following in conjunction with the accompanying drawings in the embodiments of the present invention. Obviously, the described embodiments are a part of the embodiments of the present invention and not all of the embodiments. Based on the embodiments in the present invention, all other embodiments obtained by a person of ordinary skill in the art without making creative labor fall within the scope of protection of the present invention.

The invention is further described below in accordance with embodiments.

### Embodiment 1

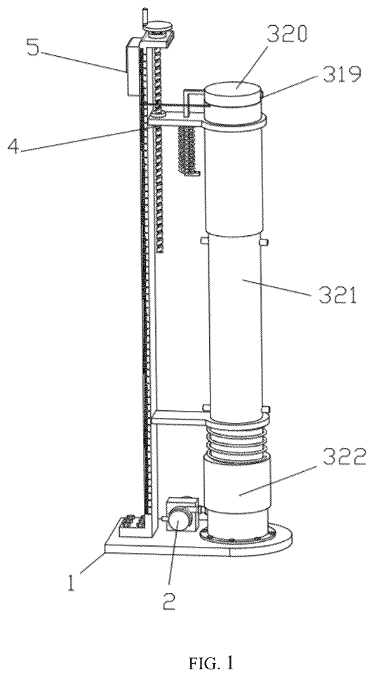

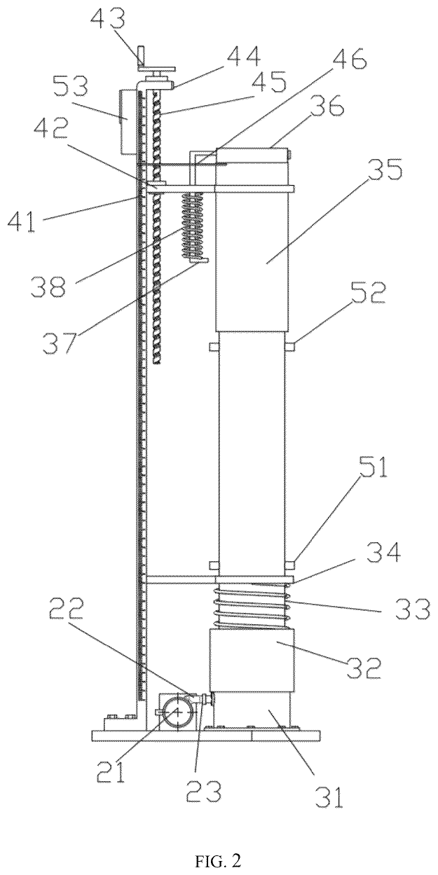

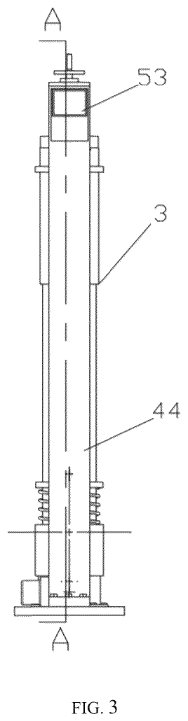

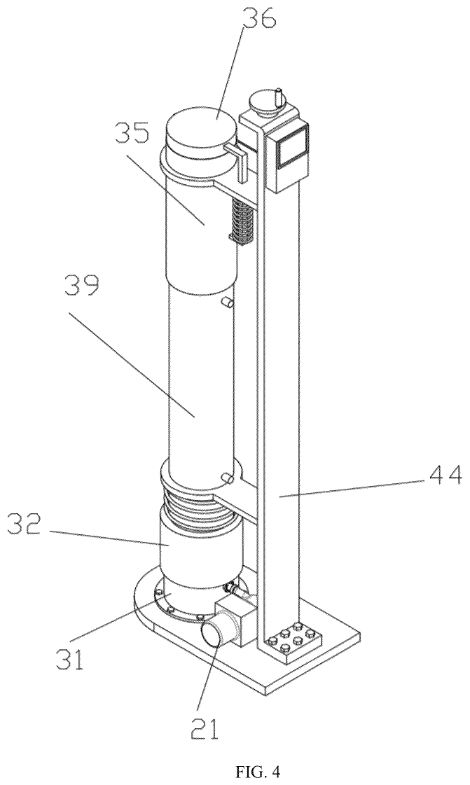

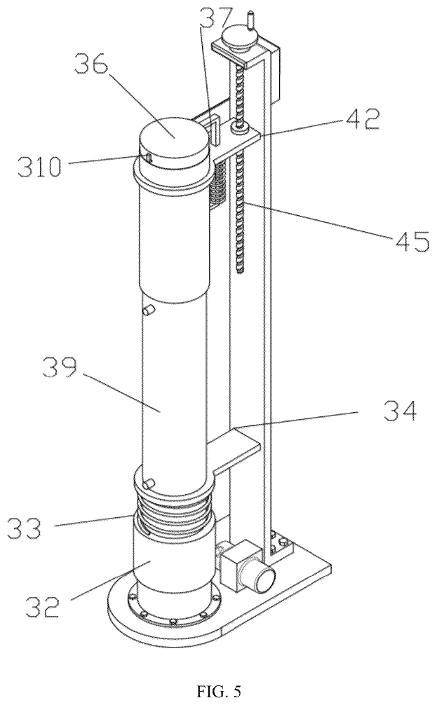

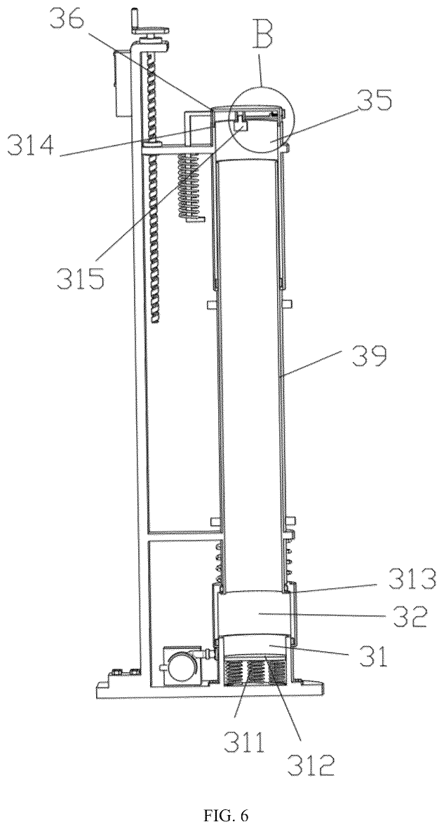

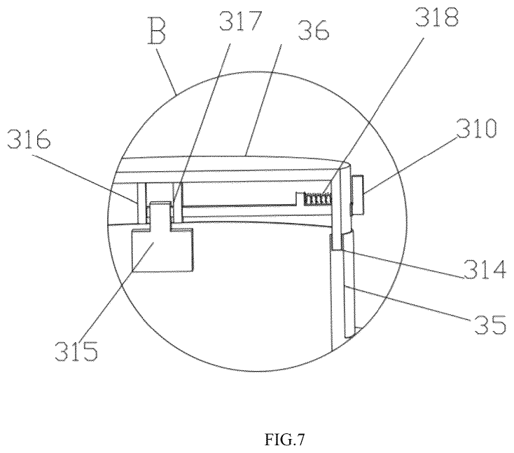

Referring to FIGS. 1 to 7, a free-fall experimental apparatus for high school physics comprises a base 1, on which a negative-pressure assembly 2 is mounted for negative-pressure pumping within an experimental assembly 3;

The base 1 is fitted with a height adjusting assembly 4 for adjusting the experimental height of the experimental assembly 3;

The base 1 is fitted with an experimental assembly 3 for performing free-fall experiments;

The experimental assembly 3 includes a pulling type movable assembly 319, an experimental block 315, an upper opening self-resetting assembly 320, a retractable assembly 321, and a lower opening self-resetting assembly 322;

The experimental block 315 is mounted on a pulling type movable assembly 319, the pulling type movable assembly 319 is mounted on an upper opening self-resetting assembly 320, the upper opening self-resetting assembly 320 is connected to the upper end of the retractable assembly 321, the retractable assembly 321 is connected to the height adjusting assembly 4, and a lower opening self-resetting assembly 322 is mounted on the base 1 and the lower opening self-resetting assembly 322 is connected to the lower end of the retractable assembly 321;

The retractable assembly 321 is fitted with a sensing assembly 5 for detecting the experimental block 315;

By moving the pulling type movable assembly 319 laterally, the experimental block 315 is detached from the pulling type movable assembly 319. during the process, the experimental block 315 does not move up and down or left and right, ensuring that the initial velocity of the experimental block 315 is zero. And then the sensing assembly 5 detects the experimental block 315 and measures the time it takes for the experimental block 315 to fall down to the detected position. The present invention satisfies that the initial velocity of the experimental block 315 is zero, and therefore helps to ensure the accuracy of calculating the acceleration of free-fall and reduce errors. After conducting a free-fall experiment, the lower open self-resetting components 322 is opened to take out the experimental block 315, and automatically reset closed when releasing, then the upper open self-resetting components 320 is opened, the experimental block 315 is mounted by pulling the pulling type activity components 319, and automatically closing of the upper open self-resetting component 320 when releasing can be realized. There is no need to adjust the experimental height back and forth during repeated experiments, and thus it is more convenient for the operation. When it requires to adjust the experimental height, the height adjusting component 4 is activated to extend the retractable component 321, so as to realize the adjustment of the experimental height. Since the same experimental height needs to be adjusted only once, this invention solves the problems in the prior art where a more cumbersome method is used to repeatedly pick up the ball and adjust the height, which is not conducive to conducting multiple repeated experiments.

### Embodiment 2

In accordance with Embodiment 1, refer to FIGS. 1 to 7, said up-opening self-resetting assembly 320 comprises a top sleeve 36, a first slide plate 37 and a second spring 38; said top sleeve 36 is plug-in mounted on the upper end of said retractable assembly 321, said first slide plate 37 is fixedly connected to the side wall of said top sleeve 36, said first slide plate 37 is slidingly connected to said height adjusting assembly 4, and said first slide plate 37 is fitted with a second spring 38, the lower end of said second spring 38 is fixedly connected to said first slide plate 37, and the upper end of said second spring 38 is fixedly connected to said height adjusting assembly 4.

Under the elastic force of the second spring 38, the second spring 38 gives a downward force to the first slide plate 37, and the first slide plate 37 gives a downward force to the top sleeve 36, allowing the top sleeve 36 to be tightly coupled to the retractable assembly 321;

The pulling type movable assembly 319 includes a pull plate 310, a first blocking plate 316, a second blocking plate 317, and a fourth spring 318. The pull plate 310 is slidingly connected to the side wall of the top sleeve 36, and the first blocking plate 316 and the second blocking plate 317 are fixedly connected to the inner bottom of the top sleeve 36, and the end of the pull plate 310 passes through the second blocking plate 317 and the experimental block 315 successively, and then contacts the side wall of the first blocking plate 316. The experimental block 315 is provided with a hole for the pull plate 310 to pass through, and the distance between the first blocking plate 316 and the second blocking plate 317 is slightly greater than the length of the upper end of the experimental block 315. The pull plate 310 is mounted with a fourth spring 318, and the fourth spring 318 is located inside the top sleeve 36, with one end being fixedly connected to the pull plate 318 and the other end being fixedly connected to the inner wall of the top sleeve 36;

Under the action of the elastic force of the fourth spring 318, the fourth spring 318 gives a force to the pull plate 310 to move in the direction close to the side of the experimental block 315;

When it requires to install the experimental block 315, the first slide plate 37 is pulled upward, causing the top sleeve 36 to be detached from the retractable assembly 321. The pulling plate 310 is pulled outward, and the experimental block 315 is placed between the first baffle plate 316 and the second baffle plate 317 and then released. Under the action of the elasticity force of the fourth spring 318, the fourth spring 318 drives the pulling plate 310 to move toward the direction close to one side of the experimental block 315. One end of the pulling plate 310 passes through the second blocking plate 317 and the experimental block 315 in sequence, and then contacts and connects to the side wall of the first blocking plate 316, thus achieving the installation of the experimental block 315. After the first slide plate 37 is released, under the action of the elastic force of the second spring 38, the second spring 38 drives the first slide plate 37 downwardly, and the first slide plate 37 drives the top sleeve 36 downwardly, so that the top sleeve 36 is automatically reset and be tightly connected with the retractable assembly 321.

The retractable assembly 321 includes an adjusting sleeve 35, a fixing sleeve 39, and an installation crossbar 34. The lower end of the fixing sleeve 39 is fixedly mounted on the installation crossbar 34, and the other end of the installation crossbar 34 is fixedly mounted on the height adjusting assembly 4, and the upper end of the fixing sleeve 39 is slidingly connected to the interior of the adjusting sleeve 35, which is connected to the height adjusting assembly 4, and adjusting sleeve 35 is provided at the top with a slot 314 for mating with the bottom of the top sleeve 36. The internal lower end of the adjusting sleeve 35 is fixedly connected with a sealing ring for sealing the connection of the adjusting sleeve 35 with the fixing sleeve 39.

The height adjusting assembly 4 drives the adjustment sleeve 35 up and down, the adjustment sleeve 35 moves up and down along the top sleeve 36, and at the same time, the adjustment sleeve 35 drives the pulling type movable assembly 319, the experimental block 315, and the up-opening self-resetting assembly 320 up and down. Thus, adjustment of the experimental height is realized.

The lower opening self-resetting assembly 322 includes a buffer sleeve 31, a slide sleeve 32, a first spring 33, a third spring 311, a buffer plate 312, and an anti-dislodgement ring 313. The bottom of the buffer sleeve 31 is fixedly mounted on the base 1. A number of sets of third springs 311 are fixedly connected to the inner bottom of the buffer sleeve 31, and the top of the third springs 311 are each fixedly connected to the buffer plate 312. The buffer plate 312 is mounted to the interior of the buffer sleeve 31. The inner wall of the lower end of the slide sleeve 32 is in close sliding contact with the outer wall of the upper end of the buffer sleeve 31, and the outer wall of the lower end of the fixing sleeve 39 is in close sliding contact with the inner wall of the top end of the slide sleeve 32. The bottom of the fixing sleeve 39 is fixedly connected to the anti-dislodging ring 313, which is in close sliding contact with the inner wall of the slide sleeve 32, and the external diameter of the anti-dislodging ring 313 is larger than the inner diameter of the top end of the slide sleeve 32. The fixing sleeve 39 has a first spring installed at the lower outer end. The lower end of the fixed sleeve 39 is externally mounted with a first spring 33 which is located below the installation crossbar 34, with the upper end fixedly connected to the installation crossbar 34, and the lower end fixedly connected to the top of the slide sleeve 32.

A sealing ring for sealing the connection between the slide 32 and the buffer sleeve 31 is fixedly connected to the lower end of the interior of the slide 32; a sealing ring for sealing the connection between the slide 32 and the fixed sleeve 39 is fixedly connected to the upper end of the interior of the slide 32;

When the lower opening self-resetting assembly 322 needs to be opened, the slide sleeve 32 is moved upwardly to detach the slide sleeve 32 from the buffer sleeve 31, and then the experimental block 315 on the buffer plate 312 is taken out, after which the slide sleeve 32 is released and the slide sleeve 32 is moved downwardly to be connected with the buffer sleeve 31 under the elastic force of the first spring 33. The position of the slide sleeve 32 is limited by the anti-disengagement ring 313 to prevent the slide sleeve 32 from being detached from the fixed sleeve 39. The buffer plate 312 and the third spring 311 cooperate to realize the buffer protection of the experimental block 315.

### Embodiment 3

In accordance with Embodiment 2, refer to FIGS. 1 to 5, the height adjusting assembly 4 comprises a scale 41, a second slide plate 42, a rocker bar 43, a support bracket 44, a threaded bar 45 and a pointer 46. The lower end of the scale 41 is fixedly connected to the base 1, the upper end of the scale 41 is fixedly connected to a support bracket 44. The support bracket 44 is rotationally mounted with a threaded bar 45. A rocker bar 43 is fixedly connected to the top of the threaded bar 45. second slide plate 42 is threadedly connected to the threaded bar 45, with one end in close sliding contact with the scale 41 and the other end in fixed connection with the upper end of the adjustment sleeve 35. The upper end of the adjustment sleeve 35 is fixedly connected to a horizontal pointer 46, which is coincident with a horizontal line where the center of gravity of the experimental block 315 is located. One end of the pointer 46 is indicated on a graduated line of the scale 41.

Being turned, the rocker bar 43 drives the threaded bar 45 to rotate, the threaded bar 45 drives the second slide plate 42 to move up and down, the second slide plate 42 drives the adjustment sleeve 35 to move up and down, the adjustment sleeve 35 drives the pointer 46 to move up and down. The pointer 46 is indicated on the scale line of the scale 41, and the experiment height value is read by the scale 41.

The other end of the installation crossbar 34 is fixedly mounted to the lower side wall of the scale 41. The first slide plate 37 is slidingly connected to the second slide plate 42. The second spring 38 is disposed underneath the second slide plate 42, with the upper end fixedly connected to the second slide plate 42.

The sensing assembly 5 includes a first infrared sensor 51, a second infrared sensor 52, and a controller 53. The first infrared sensor 51 and the second infrared sensor 52 are connected to the controller 53. The first infrared sensor 51, the second infrared sensor 52, and the controller 53 are all of existing commercially available and mature structures. The second infrared sensor 52 and the first infrared sensor 51 are fixedly mounted on the upper and lower ends of the fixing sleeve 39, respectively. The controller 53 is fixedly mounted at the upper end of the scale 41. The second infrared sensor 52 and the first infrared sensor 51 are used to sense the experimental block 315 when the experimental block 315 is free-falling. The controller 53 is built-in with a timing module which is turned on when releasing the experimental block 315. The second infrared sensor 52 and the first infrared sensor 51 sense the experimental block 315 respectively. The timing module records the time at which the experimental block 315 is sensed respectively, and the controller 53 May also display the timing results.

The negative pressure assembly 2 includes a pumping pump 21, a pumping pipe 22 and a control valve 23. The pumping pump 21 is fixedly mounted on the base 1. The pumping end of the pumping pump 21 is fixedly connected to the pumping pipe 22. The pumping pipe 22 is mounted with the control valve 23, and the other end of the pumping pipe 22 is fixedly connected to the buffer sleeve 31.

By turning on the pumping pump 21 and the control valve 23, the interior of the buffer sleeve 31 is pumped. Since the buffer sleeve 31, the slide sleeve 32, the fixed sleeve 39, the adjusting sleeve 35, and the top sleeve 36 are sealed, the interior thereof can be vacuumed and treated to improve the accuracy of the free-fall experiment.

The present invention is realized by moving the pulling type movable assembly 319 laterally to make the experimental block 315 be detached from the pulling type movable assembly 319, during which the experimental block 315 does not move up and down or left and right, and the initial velocity is zero, then detecting the experimental block 315 by the sensing assembly 5, and measuring the time it takes for the experimental block 315 to fall down to the detected position. The present invention satisfies that the initial velocity of the experimental block is zero, and therefore helps to ensure the accuracy of calculating the acceleration of free-fall and reduce errors. After conducting a free-fall experiment, the lower open self-resetting components 322 is opened to take out the experimental block 315, and automatically reset closed when releasing, then the upper open self-resetting components 320 is opened, the experimental block 315 is mounted by pulling the pulling type activity components 319, and automatically closing of the upper open self-resetting component 320 when releasing can be realized. There is no need to adjust the height of the experiments back and forth during repeated experiments, and thus it is more convenient for the operation. When it requires to adjust the experimental height, the height adjusting component 4 is activated to extend the retractable component 321, so as to realize the adjustment of the experimental height. Since the same experimental height needs to be adjusted only once, this invention solves the problems in the prior art where a more cumbersome method is used to repeatedly pick up the ball and adjust the height, which is not conducive to conducting multiple repeated experiments.

The above embodiments are only used to illustrate the technical solutions of the present invention, not to limit them; although the present invention has been described in detail with reference to the foregoing embodiments, a person of ordinary skill in the art should understand that it is still possible to make modifications to the technical solutions documented in the foregoing embodiments or to make equivalent replacements for some of the technical features therein; and such modifications or replacements will not make the nature of the corresponding technical solution The modifications or substitutions will not make the essence of the corresponding technical solutions depart from the spirit and scope of the technical solutions of the embodiments of the present invention.

What is claimed is:

1. A free-fall experimental apparatus for high school physics, comprising a base (1), wherein:
said base (1) is fitted with a negative pressure assembly (2) for negative pressure pumping inside an experimental assembly (3);
Said base (1) is fitted with a height adjusting assembly (4) for adjusting the experimental height of the experimental assembly (3);
Said base (1) is fitted with an experimental assembly (3) for performing free-fall experiments;
Said experimental assembly (3) comprises a pulling type movable assembly (319), an experimental block (315), an upper opening self-resetting assembly (320), a retractable assembly (321) and a lower opening self-resetting assembly (322);
said experimental block (315) is mounted on said pulling type movable assembly (319), said pulling type movable assembly (319) is mounted on said upper opening self-resetting assembly (320), said upper opening self-resetting assembly (320) is connected to the upper end of said retractable assembly (321), said retractable assembly (321) is connected to said height adjusting assembly (4), said lower opening self-resetting assembly (322) is mounted on said base (1), and said lower opening self-resetting assembly (322) is connected to the lower end of said retractable assembly (321);
Said retractable assembly (321) is fitted with a sensing assembly (5) for detecting said experimental block (315).

2. The free-fall experimental apparatus for high school physics according to claim 1, wherein:
said up-opening self-resetting assembly (320) comprises a top sleeve (36), a first slide plate (37) and a second spring (38); said top sleeve (36) is plug-in mounted on the upper end of said retractable assembly (321), said first slide plate (37) is fixedly connected to the side wall of said top sleeve (36), said first slide plate (37) is slidingly connected to said height adjusting assembly (4), and said first slide plate (37) is fitted with a second spring (38), the lower end of said second spring (38) is fixedly connected to said first slide plate (37), and the upper end of said second spring (38) is fixedly connected to said height adjusting assembly (4).

3. The free-fall experiment apparatus for high school physics according to claim 2, wherein:
said pulling type movable assembly (319) comprises a pulling plate (310), a first blocking plate (316), a second blocking plate (317) and a fourth spring (318); said pulling plate (310) is slidingly connected to the side wall of said top sleeve (36), and the inner bottom of said top sleeve (36) is fixedly connected with the first blocking plate (316) and second blocking plate (317), one end of said pulling plate (310) passes through said second blocking plate (317), said experimental block (315) successively and then contacts and connects to the side wall of said first blocking plate (316), said experimental block (315) is provided with a hole through which said pulling plate (310) passes, said pulling plate (310) is fitted with a fourth spring (318), said fourth spring (318) is fitted with a fourth spring (318), and said third spring (318) is fitted with a fourth spring (318), said fourth spring (318) is located interior said top sleeve (36), with one end being fixedly connected to said pull plate (310), and the other end being fixedly connected to the inner wall of said top sleeve (36).

4. The free-fall experiment apparatus for high school physics according to claim 2, wherein:
said retractable assembly (321) comprises an adjusting sleeve (35), a fixing sleeve (39) and an installation crossbar (34); the lower end of said fixing sleeve (39) is fixedly mounted on said installation crossbar (34), the other end of said installation crossbar (34) is fixedly mounted on said height adjusting assembly (4), said fixing sleeve (39) is slidingly connected at the upper end to the interior of said adjusting sleeve (35), said adjusting sleeve (35) is connected to said height adjusting assembly (4), said adjusting sleeve (35) is provided at the top with a slot (314) for mating with the bottom of said top sleeve (36); the internal lower end of said adjusting sleeve (35) is fixedly connected with a sealing ring for sealing the connection of said adjusting sleeve (35) with said fixing sleeve (39).

5. The free-fall experimental apparatus for high school physics according to claim 4, wherein:
said lower opening self-resetting assembly (322) comprises a buffer sleeve (31), a slide sleeve (32), a first spring (33), a third spring (311) and a buffer plate (312); the bottom of said buffer sleeve (31) is fixedly mounted on said base (1), and the inner bottom of said buffer sleeve (31) is fixedly connected with a number of sets of third springs (311), the top of said third springs (311) is fixedly connected with said buffer plate (312) respectively, said buffer plate (312) is mounted on the interior of said buffer sleeve (31), the inner wall of the lower end of said slide sleeve (32) is in sliding contact with the outer wall of the upper end of said buffer sleeve (31), and the outer wall of the lower end of said fixed sleeve (39) is sliding contact with the inner wall of the top of said top inner wall of said slide sleeve (32), the first spring (33) is mounted at the lower end of said fixed sleeve (39), said first spring (33) is located below said installation crossbar (34), the upper end of said first spring (33) is fixedly connected to said installation crossbar (34), the lower end of said first spring (33) is fixedly connected to said top of said slide sleeve (32).

6. The free-fall experiment apparatus for high school physics according to claim 5, wherein:
said fixed sleeve (39) is fixedly connected at its bottom with an anti-dislodgement ring (313), said anti-dislodgement ring (313) is in sliding contact with the inner wall of said slide sleeve (32), and the outer diameter of said anti-dislodgement ring (313) is larger than the inner diameter of the top of said slide sleeve (32).

7. The free-fall experiment apparatus for high school physics according to claim 5, wherein:
the internal lower end of said slide sleeve (32) is fixedly connected with a sealing ring for sealing the connection between said slide sleeve (32) and said buffer sleeve (31); the internal upper end of said slide sleeve (32) is fixedly connected with a sealing ring for sealing the connection between said slide sleeve (32) and said fixed sleeve (39).

8. The free-fall experiment apparatus for high school physics according to claim 4, wherein:
said height adjusting assembly (4) comprises a scale (41), a second slide plate (42), a rocker (43), a support bracket (44), a threaded bar (45) and a pointer (46); the lower end of said scale (41) is fixedly connected to said base (1), the upper end of said scale (41) is fixedly connected to the support bracket (44), the threaded bar (45) is rotationally mounted on said support bracket (44), the rocker (43) is fixedly connected to the top of said threaded bar (45), the threaded bar (45) is threadedly connected with the second sliding plate (42), with one end in sliding contact with the scale ruler (41), and the other end fixedly connected to the upper end of the adjusting sleeve (35), the upper end of the adjusting sleeve (35) is fixedly connected with the horizontal pointer (46), which coincides with the horizontal line where the center of gravity of the experimental block (315) is located, one end of the pointer (46) indicates the graduation line on the scale ruler (41).

9. The free-fall experiment apparatus for high school physics according to claim 8, wherein:
said sensing assembly (5) comprises a first infrared sensor (51), a second infrared sensor (52) and a controller (53); said second infrared sensor (52) and said first infrared sensor (51) are fixedly mounted at the upper and lower ends of said fixing sleeve (39) respectively, and said controller (53) is fixedly mounted at the upper end of said scale (41).

10. The free-fall experimental apparatus for high school physics according to claim 5, wherein:
said negative pressure assembly (2) comprises a pumping pump (21), a pumping pipe (22) and a control valve (23); said pumping pump (21) is fixedly mounted on said base (1), the pumping end of said pumping pump (21) is fixedly connected to a pumping pipe (22), said pumping pipe (22) is mounted with a control valve (23), the other end of said pumping pipe (22) is fixedly connected to said buffer sleeve (31).
